(19) United States
(12) Patent Application Publication
(10) Pub. No.: US 2007/0168391 A1
(43) Pub. Date: Jul. 19, 2007

(54) Product Configuration System

(76) Inventors: John Coschigano, Bethel, CT (US); Gustav Mucci, Yalesville, CT (US); Roberto Rodriguez, Newtown, CT (US); Ying Cao, Monroe, CT (US)

Correspondence Address: PERMAN & GREEN, 425 POST ROAD, FAIRFIELD, CT, 06824, US

(21) Appl. No.: 11/560,392

(22) Filed: Nov. 16, 2006

Related U.S. Application Data
(60) Provisional application No. 60/737,169, filed on Nov. 16, 2005.

(51) Int. Cl. G06F 17/00

(52) U.S. Cl. 707/104.1

(57) ABSTRACT

A method of allowing a user to configure a product includes providing the user with a number of options for the product from which to select, displaying a graphical representation of the product integrating each option as it is selected, and calculating price and availability information when the product and selected options yield a producable product. The product may include temperature measurement products and related equipment.

The disclosed embodiments relate generally to a system for configuring a product, in particular to a system that provides a user with a number of options from which to select.

### BRIEF DESCRIPTION OF RELATED DEVELOPMENTS

Often times a product may be built from a number of optional components. When a product is complex and includes many component parts, it may be difficult to remember or tabulate all the optional components available. It may also be challenging to visualize the final product taking into account a number of various selected components.

It would be advantageous to provide a system that allows a user to configure a product with desirable and compatible options. Additional advantages could be realized if the system graphically portrayed the product with the selected options, provided price and availability information when appropriate, and notified a user when incompatible options have been selected.

### SUMMARY OF THE EXEMPLARY EMBODIMENTS

The disclosed embodiments are directed to a method of allowing a user to configure a product. The method includes providing the user with a number of options for the product from which to select, displaying a graphical representation of the product integrating each option as it is selected, and calculating price and availability information when the product and selected options yield a producable product.

In another embodiment, a system for allowing a user to configure a product includes a data center and at least one user terminal having circuitry for receiving instructions from the data center and displaying a number of options for the product from which to select, displaying a graphical representation of the product integrating each option as it is selected by a user, and for displaying price and availability information calculated by the data center when the product and selected options yield a producable product.

Another embodiment includes a method for providing information to a user of temperature measurement products and related equipment and services. The method includes providing temperature measurement product options as a product configuration process accessed by a user at a user terminal, wherein the user navigates among and selects from a number of temperature measurement product options, displaying a graphical representation of the temperature measurement product incorporating the temperature measurement product option selections as they are made, and calculating price and availability information when the selections made yield a producable temperature measurement product.

### BRIEF DESCRIPTION OF THE DRAWINGS

The foregoing aspects and other features of the disclosed embodiments are explained in the following description, taken in connection with the accompanying drawings, wherein:

FIG. 1 is a block diagram of a system incorporating the features of the disclosed embodiments;

FIG. 2 shows a block diagram of a typical user terminal;

FIGS. 3 and 4 show the presentation of a product and a number of options and sub options;

FIGS. 5 and 6 show how one or more options may be graphically displayed;

FIG. 7 shows a list of one or more selected options;

FIG. 8 shows a magnified view of an option;

FIG. 9 shows pricing and availability information; and

FIG. 10 shows how additional information for an option may be accessed.

### DETAILED DESCRIPTION OF THE EXEMPLARY EMBODIMENTS

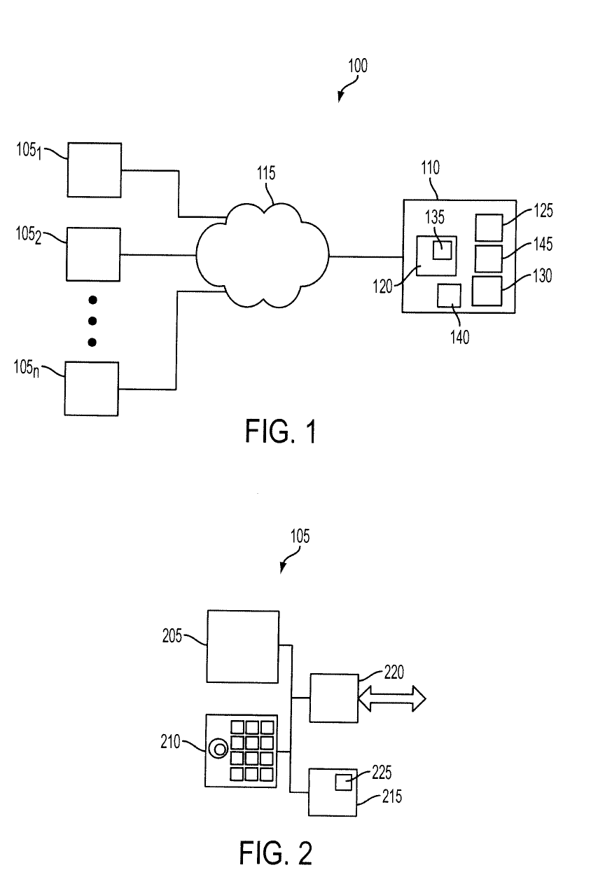

FIG. 1 shows a block diagram of a system 100 suitable for practicing the embodiments disclosed herein. Although the disclosed embodiments are described with reference to the drawings, it should be understood that the present embodiments may be realized in many alternate forms. In addition, any suitable techniques, methods, elements or structures could be used.

In the exemplary embodiment of FIG. 1, the system 100 includes a number of user terminals 105₁ . . . . 105ₙ connected to a data center 110 through a network 115.

It is a feature of the presently disclosed embodiments to provide a user with the ability to configure products with various options and embellishments, and to graphically portray the products during the configuration process. Additional features include providing pricing, availability, and delivery information, and allowing the user to place an order for the configured products. In one embodiment, the products include test and measurement equipment, for example, temperature measurement probes, strain gauges, pressure transducers, load cells, flow meters, various types of sensors, etc., and the data center is provided by an enterprise that supplies test and measurement equipment as well as related equipment and services.

Referring to FIG. 2, each user terminal 105 generally includes a display 205, an input device 210, a controller 215, and a communications interface 220. The display 205 may utilize LCD, flat panel, plasma, or any other type of suitable technology. The input device 210 may include a keypad, keyboard, a pointing device such as a mouse or trackball, etc. for selecting a number of options and embellishments of a product as will be described below. The controller 215 may include a microprocessor or other appropriate circuitry for controlling the operations of the user terminal. The controller 215 includes a storage device 225 embodied as a computer readable medium that generally stores machine readable program code which is adapted to cause controller 215 to perform the functions of the disclosed embodiments. The storage device 225 may utilize optical, magnetic, semiconductor, electronic, or other types of suitable devices to store the program code.

Examples of a user terminal 105 may include a consumer computing device such as a personal digital assistant (PDA), cellular telephone, desktop, laptop, notebook, etc. The user terminal 205 may include any computing device capable of providing the functions described herein.

Returning to FIG. 1, communications network 115 may include any suitable communications network, for example, the Internet, the Public Switched Telephone Network (PSTN), a wireless network, a wired network, a Local Area Network (LAN), a Wide Area Network (WAN), virtual private network (VPN), an air interface, etc. The communications network 115 may support any type of communications protocol, including for example, TCP/IP, X.25, ATM, etc. The air interface may include any suitable wireless communication protocols or signaling techniques or standards, for example TDMA, CDMA, IEEE 802.11, Bluetooth, close range RF, optical, any appropriate satellite communication standards, etc.

The data center 110 may include a production server 120 and a staging server 125. The production server 120 provides an interface and communication path to the user terminals 105₁ . . . . 105ₙ. The production server 120 also stores data and programs 135 on a computer readable medium for implementing the disclosed embodiments. The production server provides information to the user terminals 105₁ . . . . 105ₙ, including providing functions that allow a user to configure a product, provide the user with options for the product from which to select, graphically portray the product during configuration with each option integrated into the product as each option is selected, and provide pricing, availability, delivery, and ordering information. The staging server 130 provides an environment for program development where new programs, screens, functions, and data, and revisions to existing items may be developed and tested.

The data center may also include a rules engine 140 for various determinations including, for example, determining compatibility among different configuration options, calculating prices, availability, etc. The data center 110 may also include a database 145.

It should be understood that while one data center 110 is shown, the data center 110 may represent a number of data centers that may be located together or geographically distributed.

It should also be understood that while the product configuration process described herein is described in the context of being delivered to a user terminal from a data center through a network, other suitable delivery mechanisms may be utilized. For example, the data and programs required to implement the configuration process may be downloaded to the user terminal and operated locally, or may be provided to the user terminal on removable media.

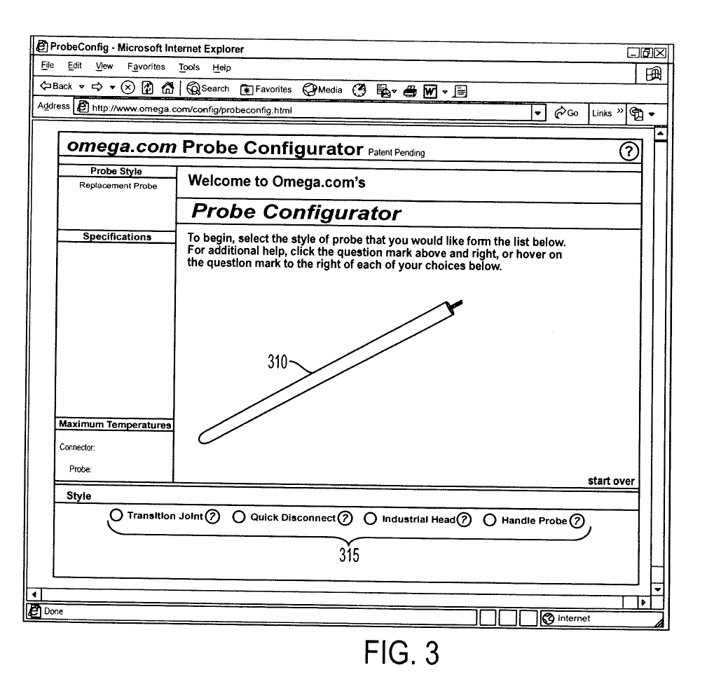

The operation of an exemplary embodiment will now be described with reference to FIGS. 3 through 10.

Referring to FIG. 3, a user may connect to the data center 110 by for example invoking a browser and typing in an appropriate uniform resource locator (URL). Upon a successful connection, the data center 110 invokes the data and programs 135. The data center interacts with the user terminal and provides data, functions as described herein, and responses to user input. Upon the successful connection configuration operations begin.

In one embodiment the user may be given a choice of the type of product to configure. In another embodiment, the URL or the method used to access the data center 110 may determine the type of product to be configured.

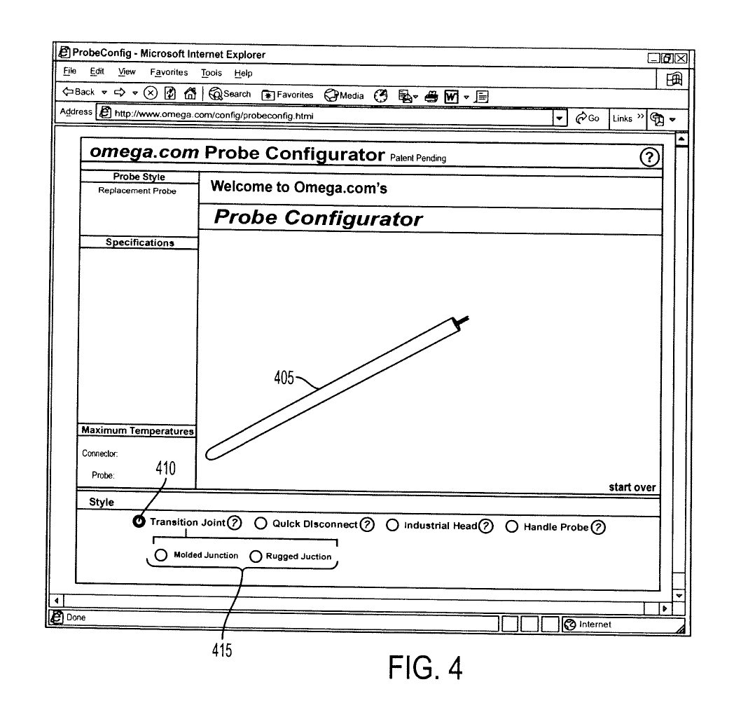

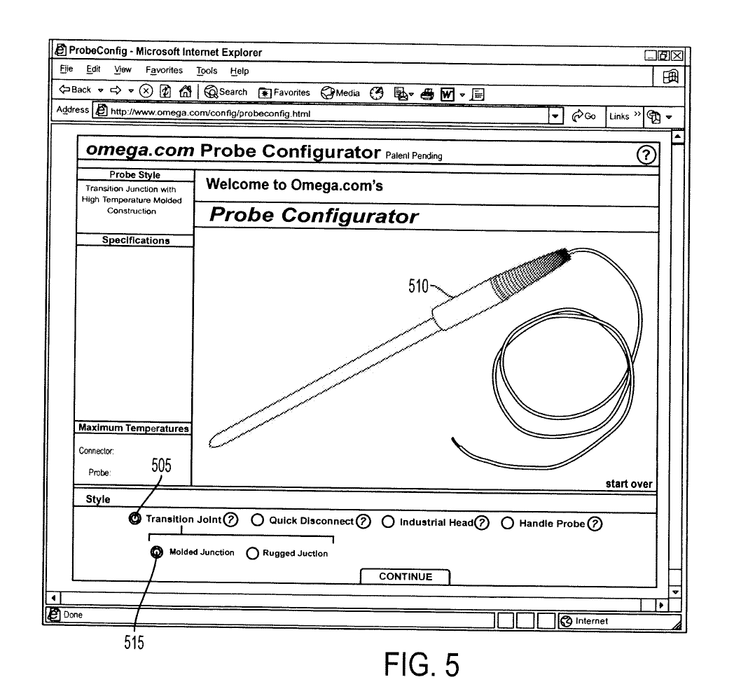

As shown in FIG. 3, once the type of product has been selected, the user is presented with an image of the product 310 and a number of option choices 315. As shown in FIG. 4, upon selecting an option 410 the user may be presented with additional choices or sub-options 415. As the user selects among the sub-options 415, further choices are presented until no further choices or options are available. As shown in FIG. 5, as the user selects various options 505 and sub-options 515, graphical representations 510 of the selections are displayed to the user, integrated with the product.

For example, FIG. 4 shows a thermocouple probe 405 with no head or handle. Turning to FIG. 5, upon selection of a transition joint 505 with a molded junction 515, a graphical representation of the transition joint 510 is displayed as it would appear integrated as part of the product. The graphical representation of the selected option may be part of a library of images stored in the data and programs 135 of the production server 120. In another embodiment, the graphical representation may be generated by a program based on parameters of the selected option. As other options and sub options are selected additional graphical representations or modifications to existing graphical representations may be displayed.

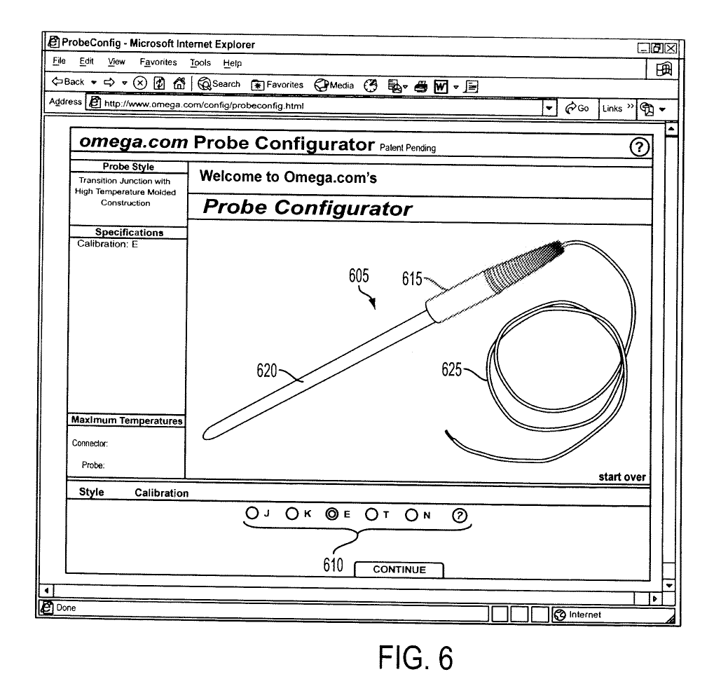

In one embodiment, certain options may be displayed using colors to differentiate among options or to signify an option. For example, FIG. 6 shows a thermocouple 605 as an exemplary product and the calibration type 610 as an option. As a user selects among the different calibration types 610, the color of a portion 615 of the thermocouple may change to indicate the calibration type selected. Other color changes may indicate the type of sheath material 620 or wire cover 625.

As another aspect of the disclosed embodiments, the selected options and sub-options, in addition to being graphically displayed may also be listed on the user terminal display.

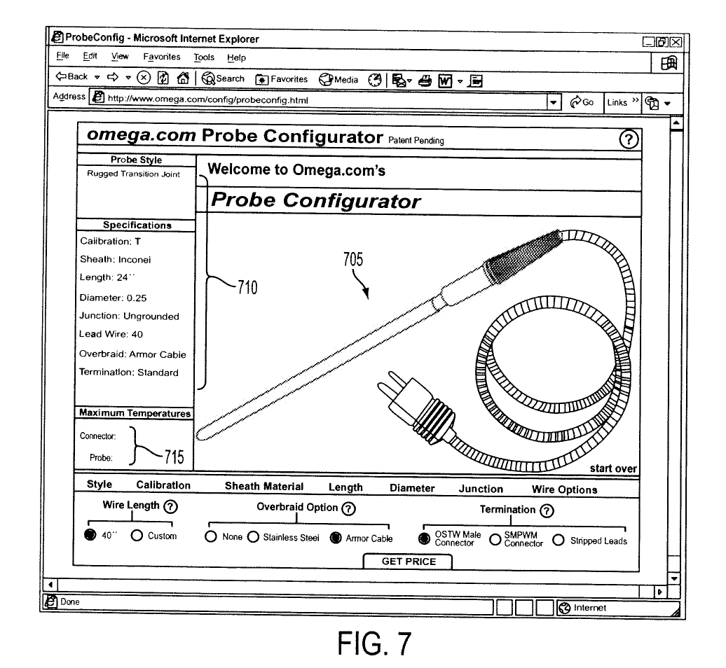

Referring to FIG. 7, an exemplary thermocouple 705 has been configured with a rugged transition joint probe style, a “T” calibration specification, an iconel sheath, and a body length of 24 inches, among other options. One or more of the options 710 selected during the configuration process are listed for reviewing in a tabular form along the left side of the display. Other features of the product may also be included such as maximum temperatures of certain components 715.

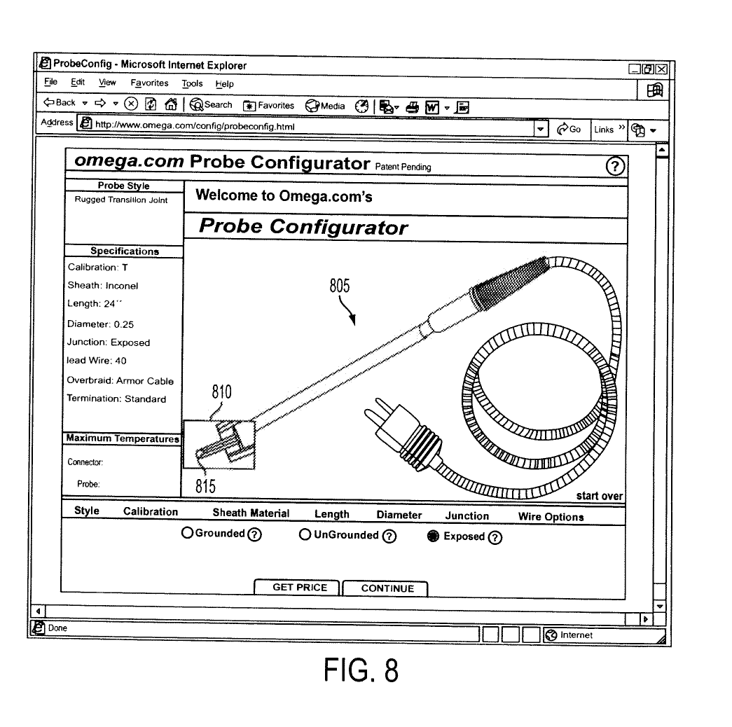

Certain options that may not be easily discernable may be displayed in a magnified view. FIG. 8 shows an example of this feature as applied to the exemplary thermocouple discussed above. The thermocouple 805 has been configured with an exposed junction, and in order to display this option clearly to a user, a magnified view 810 of the exposed junction 815 is displayed.

Upon reaching a configuration of a product that is able to be manufactured, that is economically producable, or that satisfies some other criteria for being produced by the enterprise providing the product configuration functions, a button or other type of selection device may be displayed for retrieving pricing and availability of the configured product.

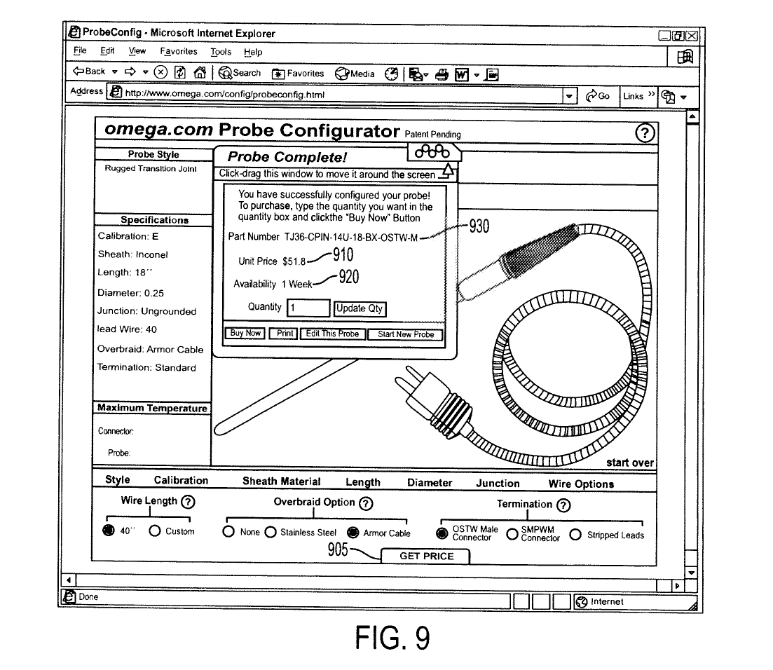

If the user makes this selection, 905 shown as “get price” in FIG. 9, the configuration process calculates and displays a price 910 from the product and options selected. The configuration process may also determine availability information 920 from the product and selected options. While a default quality of 1 is shown and used in the initial calculation, the user may change the quality and the pricing 910 and availability 920 may be updated accordingly. The rules engine 140 (FIG. 1) may be used for calculating this pricing and availability information.

In addition to pricing and availability, the configuration process may calculate a part number 930 for the product as configured and store the part number in database 145 (FIG. 1) for future retrieval.

As the user navigates through the various options and sub options for the product, the user may be alerted by error messages or help messages that may be displayed when incompatible options are selected. The rules engine 140 (FIG. 1) may be used to determine when incompatible selections have been made.

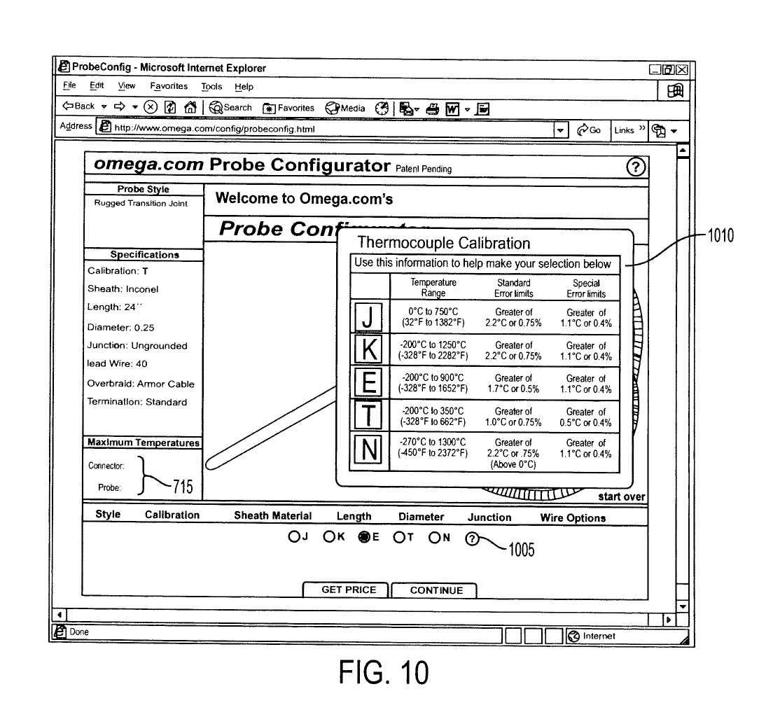

As another feature of the disclosed embodiments help may be provided for certain options. An area may be provided near an option or set of options that causes an explanation of the option to be displayed upon a prompt by the user. For example, in FIG. 10, a user while in the process of selecting a calibration has prompted the system for help by placing the cursor over an area 1005 that indicates that help is available. In response, a table 1010 showing characteristics of different calibration indications is displayed.

It should be understood that the foregoing description is only illustrative of the disclosed embodiments. Various alternatives and modifications can be devised by those skilled in the art without departing from the embodiments disclosed herein. Accordingly, the presently disclosed embodiments are intended to embrace all such alternatives, modifications and variances which fall within the scope of the appended claims.

What is claimed is:

1. A method of allowing a user to configure a product comprising:
providing the user with a number of options for the product from which to select;
displaying a graphical representation of the product integrating each option as it is selected; and
calculating price and availability information when the product and selected options yield a producable product.

2. The method of claim 1, further comprising alerting the user when incompatible options have been selected.

3. The method of claim 1, further comprising providing further information about an option when requested by the user.

4. The method of claim 1, further comprising displaying the options using colors.

5. The method of claim 1, further comprising listing the selected options in tabular form.

6. The method of claim 1, further comprising displaying certain options in a magnified view.

7. The method of claim 1, further comprising displaying an explanation of an option when prompted by the user.

8. The method of claim 1, wherein the product includes temperature measurement products and related equipment.

9. A system for allowing a user to configure a product comprising:
a data center; and
at least one user terminal having circuitry for receiving instructions from the data center and displaying a number of options for the product from which to select, displaying a graphical representation of the product integrating each option as it is selected by a user, and for displaying price and availability information calculated by the data center when the product and selected options yield a producable product.

10. The system of claim 9, wherein the data center includes a rules engine for determining compatibility among different configuration options.

11. The system of claim 9, wherein the user terminal is configured to alert the user when incompatible options have been selected.

12. The system of claim 9, wherein the user terminal is configured to display further information about an option when requested by the user.

13. The system of claim 9, wherein the user terminal is configured to display the options using colors.

14. The system of claim 9, wherein the user terminal is configured to list the selected options in tabular form.

15. The system of claim 9, wherein the user terminal is configured to display an explanation of an option when prompted by the user.

16. The system of claim 9, wherein the product includes temperature measurement products and related equipment.

17. A method for providing information to a user of temperature measurement products and related equipment and services, comprising:
providing temperature measurement product options as a product configuration process accessed by a user at a user terminal, wherein the user navigates among and selects from a number of temperature measurement product options;
displaying a graphical representation of the temperature measurement product incorporating the temperature measurement product option selections as they are made; and
calculating price and availability information when the selections made yield a producable temperature measurement product.
